(19) United States
(12) Patent Application Publication
(10) Pub. No.: US 2025/0148176 A1
(43) Pub. Date: May 8, 2025

(54) SEVERE WEATHER VORTEX DISRUPTION SYSTEM AND METHOD

(71) Applicant: The Government of the United States of America, as represented by the Secretary of Homeland Security, Washington, DC (US)

(72) Inventor: Mark Fry, Marco Island, FL (US)

(73) Assignee: The Government of the United States of America, as represented by the Secretary of Homeland Security, Washington, DC (US)

(21) Appl. No.: 18/912,204

(22) Filed: Oct. 10, 2024

Related U.S. Application Data
(60) Provisional application No. 63/547,620, filed on Nov. 7, 2023.

(51) Int. Cl. G06F 30/28; A01G 15/00; G06F 113/08

(52) U.S. Cl. CPC G06F 30/28; A01G 15/00; B64G 99/00; F24S 23/70; G06F 2113/08

(57) ABSTRACT

In an example, a system to modify a severe weather vortex comprises a controller configured to specify initial conditions for formation of the severe weather vortex, model the severe weather vortex with equations of fluid dynamics based on the initial conditions to produce a simulated severe weather vortex, and computationally add energy to a vortex generation area at an upper part of the simulated severe weather vortex to modify the simulated severe weather vortex to disrupt at least one of the formation or a travel path of the simulated severe weather vortex. A steerable mirror is oriented to focus solar energy from the sun at a vortex generation area at an upper part of the severe weather vortex based on the energy computationally added to modify the simulated severe weather vortex.

### CROSS-REFERENCE TO RELATED APPLICATIONS

The application claims the benefit of priority from U.S. Provisional Patent Application No. 63/547,620, filed Nov. 7, 2023, entitled HURRICANE DISRUPTION SYSTEM AND METHOD, the disclosure of which is incorporated by reference in its entirety.

### SUMMARY STATEMENT OF GOVERNMENT INTEREST

The present invention was made with support from the United States Department of Homeland Security (DHS) and by an employee of DHS in the performance of their official duties. The U.S. Government has certain rights in this invention.

### FIELD

The discussion below relates generally to severe weather mitigation and, more particularly, to system and method for disrupting, mitigating, or destroying severe weather events including vortex formation sever weather such as hurricanes.

### BACKGROUND

Hurricanes have long been one of nature's most destructive events causing great property damage and loss of life. Another aspect of extreme weather is the phenomenon of Derechos. https://www.spc.noaa.gov/misc/AbtDerechos/derechofacts.htm. Similar to hurricanes, which are three-dimensional (3D), derechos form from uneven heating of the surface atmosphere, but evolve into a two-dimensional (2D) system that encompasses a large area. The vorticity exists but loses the 3rd spatial component which results in different motion. Fluid dynamics still governs the process and results in destructive winds over large areas.

### SUMMARY

Embodiments of the present invention are directed to disrupting a severe weather event including a severe weather vortex such as a hurricane by directing enough energy to the vortex ring of the vortex (e.g., torus of the hurricane) to increase dissipation through vortex generation. In one example, a large orbital mirror or reflector is oriented to focus solar energy at the upper parts of the hurricane. This can lead to significant modification of its scale and energy distribution, causing at least lessening of the strength and possible degradation of the hurricane to tropical storm status.

Christopher Landsea, a hurricane expert with the National Oceanic and Atmospheric Administration, said: “A hurricane is a pretty inefficient heat engine. Only about a half percent of all the energy that's being released is actually captured by the hurricane to warm the air locally, lower the pressure, and spin the winds out.” “Tropical Cyclone Motion and Surrounding Parameter Relationship” by George et al. states: “The steering concept hypothesizes that tropical cyclones are vortices embedded in the basic environmental flow and should thus move with the so-called ‘steering current.’”

Based on the prior concept of using mirrors to provide reflected sunlight at night, this disclosure proposes the use of parabolic reflectors or mirrors for increased daylight and/or electricity generation to effect hurricane modification. More specifically, this disclosure proposes an unusual approach that focuses solar radiation onto the vortex generation area of the hurricane with the goal of disrupting the semi-steady state phenomena that allows the hurricane event to persist until landfall or cooler ocean waters are encountered. Preliminary calculations indicate that if one can add enough additional energy to the torus of a hurricane, increasing dissipation through vortex generation, through the deployment of a large orbital mirror properly oriented to focus solar energy, then it can cause at least lessening of the strength and possible degradation of a hurricane to tropical storm status. This research work includes a postulation of employing large quantities of focused solar energy onto the upper parts of the hurricane coupled with numerical simulations, which are used to validate the concept. If the use of directed energy (e.g., mirrors using solar energy) works for breaking up the vortex, then a similar approach could be made for the dissipation of derechos.

Recent work by Dr. Kerry Emanuel on the interaction of convection with large-scale flows suggests that a closure based on a presumed equilibrium between surface enthalpy fluxes and input of low-entropy air into the subcloud layer by convective down drafts works well in models of the tropical atmosphere. Kerry Emanuel served as professor and director of the Program in Atmospheres, Oceans, and Climate in the Department of Earth, Atmospheric, and Planetary Sciences at the Massachusetts Institute of Technology, Cambridge, MA 02139, U.S.A., from July 2009 to January 2012. Such a convective representation is here used in a simple numerical tropical cyclone model. This further simplifies the model while in many respects improving its performance.

Finding an alternative to one of the most disruptive and destructive events in nature, hurricanes, is the basis of this disclosure. Building a mega-mirror to focus solar energy onto an existing hurricane could lead to significant modification of its scale and energy distribution and subsequent quieting of its destructive effects. The use of radiative heating within the hurricane torus using vortex generation is the mechanism that can overcome the semi-steady state nature of a hurricane.

In accordance with an aspect, a system to modify a severe weather vortex comprises a controller configured to specify initial conditions for formation of the severe weather vortex, model the severe weather vortex with equations of fluid dynamics based on the initial conditions to produce a simulated severe weather vortex, and computationally add energy to a vortex generation area at an upper part of the simulated severe weather vortex to modify the simulated severe weather vortex to disrupt at least one of the formation or a travel path of the simulated severe weather vortex. A steerable mirror is oriented to focus solar energy from the sun at a vortex generation area at an upper part of the severe weather vortex based on the energy computationally added to modify the simulated severe weather vortex.

In accordance with another aspect, a method of modifying a severe weather vortex comprises: specifying initial conditions for formation of the severe weather vortex; modeling the severe weather vortex with equations of fluid dynamics based on the initial conditions to produce a simulated severe weather vortex; computationally adding energy to a vortex generation area at an upper part of the simulated severe weather vortex to modify the simulated severe weather vortex to disrupt at least one of the formation or a travel path of the simulated severe weather vortex; and steering a mirror to focus solar energy from the sun at an upper part of the severe weather vortex to modify the severe weather vortex based on the computationally added energy to modify the simulated severe weather vortex.

Another aspect is directed to a non-transitory computer-readable recording medium storing a program including instructions that cause a processor to execute a severe weather vortex modification operation. The operation comprises: specifying initial conditions for formation of the severe weather vortex; modeling the severe weather vortex with equations of fluid dynamics based on the initial conditions to produce a simulated severe weather vortex; computationally adding energy to a vortex generation area at an upper part of the simulated severe weather vortex to modify the simulated severe weather vortex to disrupt at least one of a formation of the simulated severe weather vortex or a travel path of the simulated severe weather vortex; and generating instructions on steering a mirror to focus solar energy from the sun at an upper part of the severe weather vortex to modify the severe weather vortex based on the energy computationally added to modify the simulated severe weather vortex.

In some embodiments, the instructions on steering the mirror may comprise instructions on steering an orbital mirror stationed at a geosynchronous orbit, or instructions on steering a set of reflectors mounted on a plurality of water surface vehicles.

Other features and aspects of various examples and embodiments will become apparent to those of ordinary skill in the art from the following detailed description which discloses, in conjunction with the accompanying drawings, examples that explain features in accordance with embodiments. This summary is not intended to identify key or essential features, nor is it intended to limit the scope of the invention, which is defined solely by the claims.

### BRIEF DESCRIPTION OF THE DRAWINGS

The attached drawings help explain the embodiments described below.

FIG. 1A is a phenomenology diagram illustrating sizing hurricane target.

FIG. 1B shows a typical flow of a hurricane as an example of a severe weather vortex event.

FIG. 1C illustrates the requirement for additional upward (left side) and downward (right side) subgrid scale motion necessary to satisfy tropical heat and moisture budgets.

FIG. 2 illustrates an example of the gradients in a flow leading to vorticity.

FIG. 3 illustrates the relative incident solar radiation on top of atmosphere (top) and surface (bottom).

FIG. 4 is a schematic diagram of a steerable mirror system illustrating the concept for a hurricane mitigation program.

FIG. 5 illustrates an example of the relative vorticity inside the hurricane torus with and without added solar radiation.

FIG. 6 shows a flow diagram illustrating an example of establishing a modeling system for hurricane modification analysis.

FIG. 7 illustrates a computing system including logic according to an embodiment.

### DETAILED DESCRIPTION

A number of examples or embodiments of the present invention are described, and it should be appreciated that the present invention provides many applicable inventive concepts that can be embodied in a variety of ways. The embodiments discussed herein are merely illustrative of ways to make and use the invention and are not intended to limit the scope of the invention. Rather, as will be appreciated by one of skill in the art, the teachings and disclosures herein can be combined or rearranged with other portions of this disclosure along with the knowledge of one of ordinary skill in the art.

### Severe Weather Vortex Structure

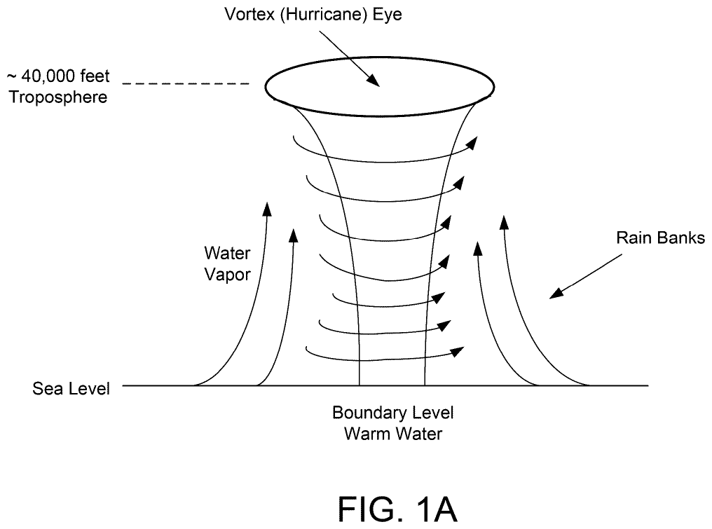

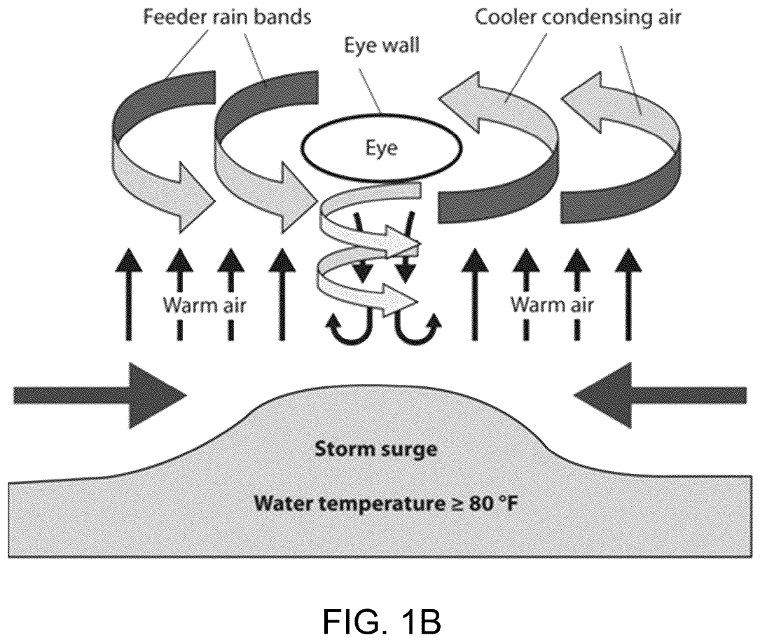

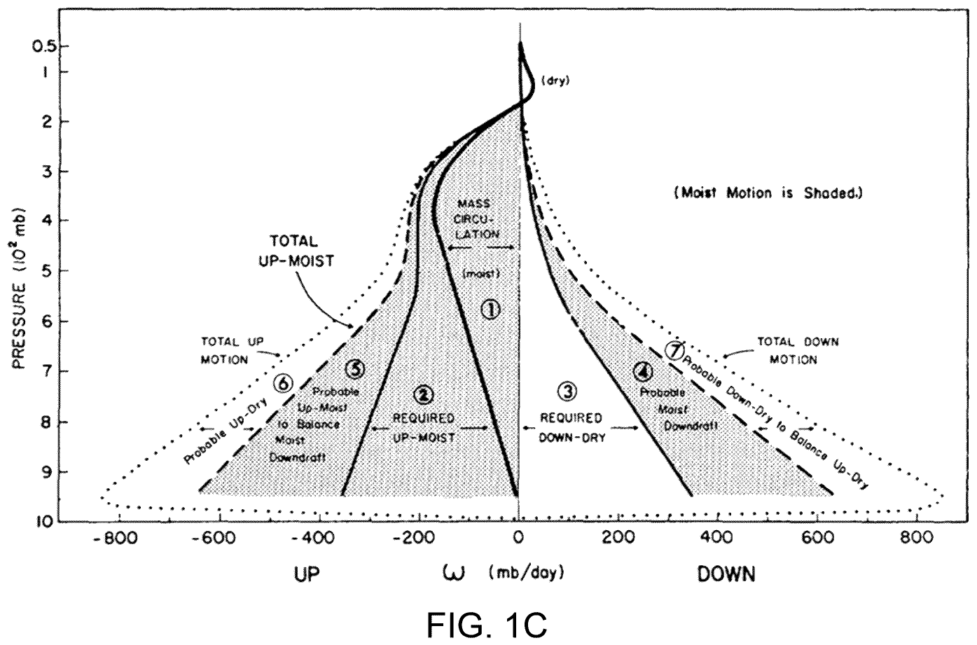

FIG. 1A is a phenomenology diagram illustrating sizing hurricane target. The diagram has a center rising vortex structure. The goal of hurricane disruption or mitigation is to disrupt a 3D (3 dimensional) vorticity and reduce it to a 2D (2 dimensional) one.

There are six widely accepted conditions for hurricane development. The fourth, which is one of the most important ingredients, is that of a low vertical wind shear, especially in the upper level of the atmosphere. Wind shear is a change in wind speed with height. Strong upper-level winds destroy the storm's structure by displacing the warm temperatures above the eye and limiting the vertical accent of air parcels. Hurricanes will not form when the upper-level winds are too strong. A hurricane needs special physical conditions to form, and then maintain or increase its energy footprint as it moves across water. Strong external forces can disrupt the formation and travel path. Therefore, it is reasonable to conclude that adding external energy above the special conditions inside the hurricane will have significant effects.

FIG. 1B shows a typical flow of a hurricane as an example of a severe weather vortex event. Within a hurricane event, the heat of the water vapor lifted from the ocean surface produces and maintains a vertical stem, characterized by the lower pressure that allows heat to rise vertically across a horizontal scale radius of approximately 5-30 km. Indeed, it is the formation of low-pressure regions over the ocean surface that promotes the evolution of a hurricane event. Any energetic event, such as fire, explosion, etc., produces a similar looking stem and torus, given the nature of the atmosphere. Especially familiar are the surface nuclear and non-nuclear explosions that lead to crisp stems and tori. Most of these singular events have energy added during the first second. Hurricanes have time scales on the order of hours and days. While the overall time scale is days, sub scales are at work within each hurricane event. Transition from a low-pressure region over the warm ocean water to a tropical storm, then to hurricanes of classifications I, II, III, and IV are often said to strengthen overnight, suggesting time scales of hours.

The modeling of tropical storms in the 1970s focused on the interaction between cumulonimbus convection and the surrounding circulation. William M. Gray made three major contributions: (a) structure of tropical weather systems, (b) convective mechanisms for heating and drying the large scale, and (c) Diurnal variation of cumulonimbus convection and theory of convective-radiative feedbacks. Philip J. Klotzbach et al., “The Science of William M. Gray: His Contributions to the Knowledge of Tropical Meteorology and Tropical Cyclones,” American Meteorological Society, DOI: https://doi.org/10.1175/BAMS-D-16-0116.1, pages 2311-2336 November 1, 2017.

With regard to the first contribution, the structure of tropical weather systems represents the parent synoptic-scale structure or a “grid-scale average” over the mesoscale components. The basic dynamic structure documented was a two-layer structure, with inflow (convergence) and cyclonic vorticity from the surface up to approximately 400 hPa, capped by a layer characterized by divergence and anticyclonic vorticity. Modern studies focus on the structure of the embedded squall lines including downdrafts, stratiform regions, and midlevel mesoscale convective vortices.

The second contribution focuses on theoretical energy balances in the tropics towards an understanding of the interaction between cumulonimbus convection and the large-scale environment. The key physical insight is that the observed grid-scale upward vertical motion in regions of convective activity is a residual between a large upward mass flux in protected cumulonimbus cores and a large downward motion (or compensating subsidence) in a larger area between these cores. FIG. 1C illustrates the requirement for additional upward (left side) and downward (right side) subgrid scale motion necessary to satisfy tropical heat and moisture budgets. The additional upward motion is hypothesized to take place in convective updrafts, while the downward motion includes clear air compensating subsidence, as well as moist downdrafts. Cloud impacts were carried out by a subgrid-scale up-moist, down-dry circulation.

With regard to the third contribution relating to Diurnal variation of cumulonimbus convection and theory of convective-radiative feedbacks, the proposition was that deep convection is driven by diurnally varying horizontal pressure gradients that respond to the radiative-convective heating profile differences between cloud-covered and surrounding cloud-free areas.

### Severe Weather Vortex Modification

Building a mega-mirror to focus solar energy onto an existing severe weather vortex such as a hurricane could lead to significant modification of its scale and energy distribution and subsequent quieting of its destructive results. One feature of the approach is to apply radiative heating within the hurricane torus using vortex generation to overcome the semi-steady state nature of the hurricane. Another feature is to focus larger quantities of solar energy onto the upper parts of the hurricane and perform numerical simulations to validate the concept.

It is believed that there are two places, in spatial terms, on which to focus the solar energy: the surface under the stem, where the energy for the hurricane emanates, and the torus, which extends up through the troposphere. The physics of the torus provides the ongoing angular momentum. While one can conceive of approaches with devices that would somehow separate the energy source (warm ocean water) from the stem, the scale and horizontal motion of the hurricane event make such an approach a time-dependent, multi-dimensional nightmare.

The rise of a significant energetic event, fire, explosion, or cyclonic event leads to the semi-steady state cloud. Energy that was converted from chemical, nuclear, or thermal leads to higher temperatures with convective transfer along with higher velocities of the local atmosphere. This area is sometimes described as the mushroom cloud stem. Matter once on the surface travels upward into the torus via a complicated flow field leading to considerable vorticity during the event. The decreasing density and pressure of the surrounding atmosphere with increasing altitude provides the ambient background for the disturbed flow field.

The vorticity transport equation for inviscid flow is as follows:

Dw/Dt=w·Ñv+r−3(Ñr×Ñp)+r−1Ñ×f (1)

The quantity w°z/r is a modified form of the vorticity. It is easily verified that Equation (1) reduces to the inviscid form when the density is taken to be a constant.

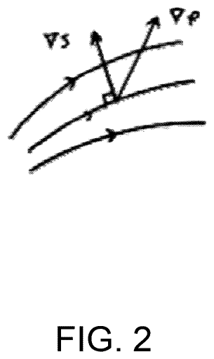

FIG. 2 illustrates an example of the gradients in a flow leading to vorticity. The term on the left-hand side of Equation (1) is recognized as the time rate of change of the modified vorticity w following a blob of fluid. Thus, Equation (1) represents the variation of w of a fluid particle over time t. The first term on the right-hand side of Equation (1), i.e., w·Ñv, is essentially the same as the “vortex-stretching” term. This term does not generate new vorticity. Rather, it simply distorts the vorticity already present in the flow.

The last two terms in Equation (1) are responsible for the creation of new vorticity in the flow. This fact can be seen by considering a flow for which w is initially zero. Then Equation (1), applied at this initial instant, clearly requires that w increases or decreases at the initial instant, provided the sum of the Ñr×Ñp term and the body force term is non-zero. Alternatively, one can simply note that the last two terms in Equation (1) are inconsistent with w=0 solutions.

The body force term, i.e., the last term in Equation (1), will generate vorticity whenever the body force density does not correspond to a conservative force field. While gravitational body forces are conservative, non-conservative forces can be generated by rotating coordinate systems and electromagnetic forces.

Although the last term in Equation (1) plays a role in incompressible flows, the Ñr ×Ñp is non-zero only if there are significant density variations in the flow. This term is referred to as the baroclinic generation term. The baroclinic mechanism for vorticity generation is frequently invoked to explain the existence and direction of off-shore and on-shore breezes and the generation of vorticity in compressible flows.

The baroclinic generation mechanism will be non-zero whenever the density and pressure gradients are not aligned. On the other hand, this generation mechanism will vanish whenever the pressure and density gradients are parallel, even in flows having significant density gradients. The pressure gradients will be parallel to Ñr if some thermodynamic variable is uniform in the flow of interest.

By modifying the dynamics of the torus, this disclosure proposes to change the steady state nature of the hurricane event (or severe weather vortex status) to arrive at a greatly degraded hurricane event (or greatly degraded severe weather vortex status). Taking away energy in nature is rarely an option. This disclosure proposes adding energy over a localized portion of the hurricane's physical extent. More specifically, it proposes adding energy on one side or near the top leading edge of the torus over the period of many hours by making use of a large solar mirror stationed at an appropriate geosynchronous orbit. A solar mirror contains a substrate with a reflective layer disposed on the substrate for reflecting the solar energy, and in most cases an interference layer disposed on the substrate. The solar mirror has a sufficient size to direct enough energy from orbit onto the hurricane and achieve the disruption, degradation, or destruction of the severe weather event. A geosynchronous orbit (GEO) is a prograde, low inclination orbit about Earth having a period of 23 hours 56 minutes 4 seconds. A spacecraft in geosynchronous orbit appears to remain above Earth at a constant longitude, although it may seem to wander north and south.

Technological advances can overcome engineering and logistical challenges of this large undertaking. While the cost may seem prohibitive, the most recent damage costs in the range of many tens of billions of dollars from a single hurricane would pay for the endeavor.

### Energy Considerations

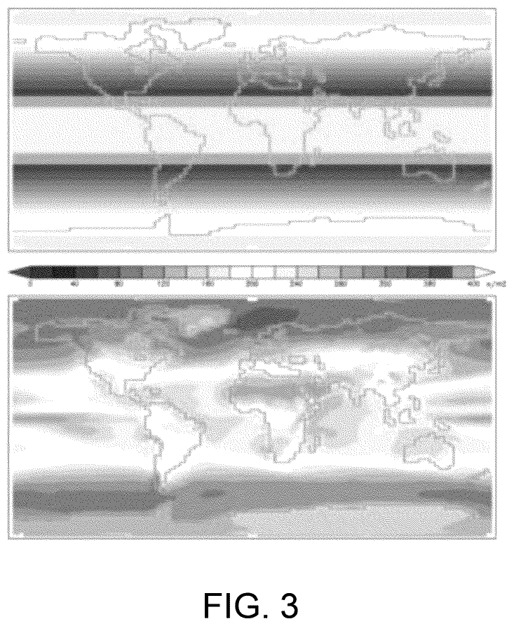

Focusing an energy source onto the hurricane can provide a subsequent temperature-energy increase in the torus. The mirror is envisioned to be over a hundred square meters in size (e.g., many hundreds of square meters) with a focusing (steerable) ability. Nominal solar heating from the sun of 5 kilowatt hours per meter square can be increased through focusing. FIG. 3 illustrates the relative incident solar radiation on top of atmosphere (top) and surface (bottom). The normal insolation of the sun upon the top of the atmosphere and at the surface is shown. Obviously, the area where hurricanes arise is optimum from an availability of solar energy. Also, since the idea is to attack the torus, which reaches altitudes of 25,000 to 40,000 feet, there is less absorption and reflection of solar energy from the interaction of the ambient atmosphere.

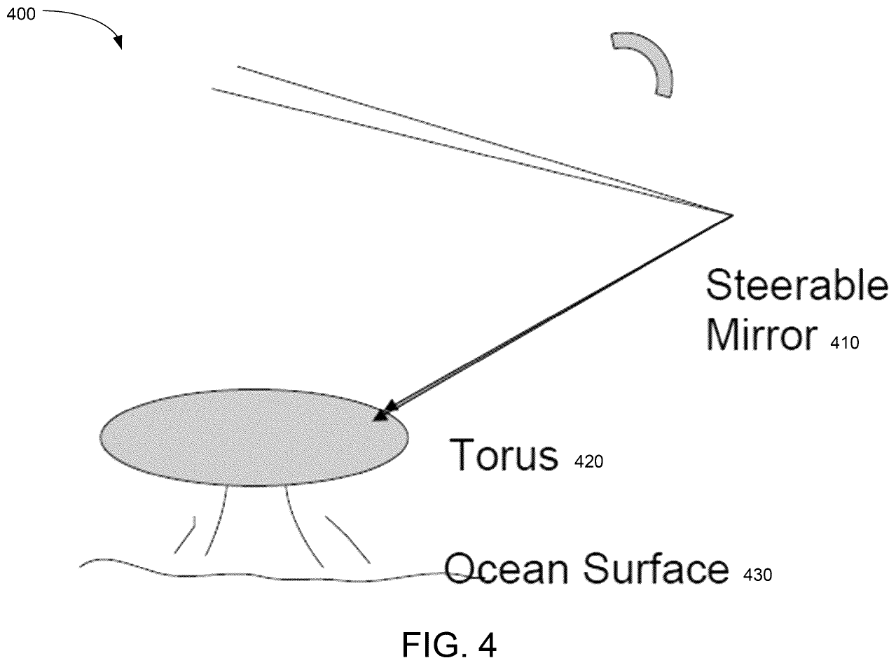

FIG. 4 is a schematic diagram of a steerable mirror system illustrating the concept for a hurricane mitigation program. The steerable mirror 410 may be designed to net a minimum ten-fold gain in energy deposited onto the torus 420 of the hurricane event above the ocean surface 430. The steerable mirror 410 is configured to produce an amount of energy which is sufficient to alter and disrupt the flow and cause the semi-steady state conditions to collapse. Various examples of orbiting solar mirrors and steering mechanisms are known in the art. See, e.g., Lewis M. Fraas et al., “Mirror Satellites in Polar Orbit Beaming Sunlight to Terrestrial Solar Fields at Dawn and Dusk,” published in 2013 IEEE 39th Photovoltaic Specialists Conference (PVSC), Jun. 16-21, 2013, https://ieeexplore.ieee.org/stamp/stamp.jsp?tp=&arnumber=6745046; “Mirrors in the sky: Status, sustainability, and some supporting materials experiments,” Renewable and Sustainable Energy Reviews, Vol. 18, February 2013, pages 401-415, https://www.sciencedirect.com/science/article/abs/pii/S1364032112005059; Anthony Cuthbertson, “Giant mirrors to reflect sunlight away from Earth may be needed to hit climate targets, UN says,” February 28, 2023, https://www.independent.co.uk/tech/climate-change-solar-radiation-mirrors-geoengineering-b2291183.html; “Enhancing terrestrial solar power using orbiting solar reflectors,” Acta Astronautica, Vol. 195, June 2022, pages 276-286, https://www.sciencedirect.com/science/article/abs/pii/S009457652201138; U.S. Patent No. 10,144,533, entitled LARGE-SCALE SPACE-BASED SOLAR POWER STATION: MULTI-SCALE MODULAR SPACE POWER; U.S. Patent Application Publication No. 2010/0276547, entitled SYSTEMS FOR SOLAR POWER BEAMING FROM SPACE; EP 0794121A1 entitled Spacecraft Sun-Target Steering About an Arbitrary Body Axis, published Sep. 10, 1997; and EP 0785132A1 entitled Dynamic Bias for Orbital Yaw Steering, published Jan. 16, 1996, the entire disclosures of which are incorporated herein by reference.

The basis for modeling a hurricane or any atmospheric phenomena is found in the Navier-Stokes equations. A subset of these equations are called hydrodynamic equations or Euler equations, but they do include conservation of mass, balance of momentum, balance of energy, and a temperature pressure relationship or the equation of state. Air is compressible and modeling an event such as a hurricane requires sub models. These sub models account for energy being transferred from the water to the air and other forces such as Coriolis forces and external winds, variable heating of the sea water, and other energy rich phenomenon. All modeling of large-scale events such as a hurricane requires large computers and the creation of accurate time varying boundary conditions.

For solutions of the equations, one has many choices, explicit or implicit. They all require a grid or matrix of points that tracks the physical parameters of the air (the term fluid, even for a gas, is used). The two types of gridding (a grid of mathematical points that surrounds the region of interest) are Eulerian and Lagrangian. Today there are many commercially offered modeling codes that contain tools that can be used to simulate the hurricane. The COMSOL Multiphysics® software is one example. It is a general-purpose simulation software based on advanced numerical methods. It has fully coupled Multiphysics and single-physics modeling capabilities. It offers a complete modeling workflow, from geometry to results evaluation. It provides a platform to create physics-based models and simulation applications. It has a Model Builder that enables one to combine multiple physics in any order for simulations of real-world phenomena, an Application Builder to build one's own simulation apps, and a Model Manager as a modeling and simulation management tool.

The present approach uses a finite difference computer modeling code based on Navier-Stokes equations to modify a hurricane. It starts by generating a reasonable numerical model of the initial formation activity. Then it performs what ifs to determine the minimum amount of external energy required to significantly alter the development of a storm.

There are two steps to achieving the answer above. Because the time scales involve hours over smaller distances, it is believed that only a smaller portion of the torus needs to be energetically enhanced. Some of these time scales can be modeled with finite difference or finite element computer codes that solve the Navier Stokes equations. This study employed several of these codes to perform preliminary assessment of the feasibility of adding energy at the torus with a resulting modification that is significant. See “Adaption of Flux-Corrected Transport Algorithms for Modelling Blast Waves,” by D. Book, J. Boris, M. Fry, R. Guirgus, A. Kuhl, 8th International Conference on Numerical methods in Fluid Dynamics, Aachen, W. Germany, July 1982, ADA120585, the entire disclosure of which is incorporated herein by reference.

### Computational Modeling

In the computational grids of the simulation codes, the initial conditions are provided by the surface wind analysis of the Hurricane Research Division of NOAA through their HRD Surface Wind Analysis System, Powell, M. D., S. H. Houston, L. R. Amat, and N. Morissea-Leroy, 1998: “The HRD real-time hurricane wind analysis system,” J. Wind Engineer and Industrial Aerodynamics 77 & 78, pages 53-64 (1998), the entire disclosure of which is incorporated herein by reference. See Background on the HRD Surface Wind Analysis System H*Wind, https://www.aoml.noaa.gov/hrd/Storm_pages/background.html, the entire disclosure of which is incorporated herein by reference. See also Convection And Moisture EXperiment 3 (CAMEX-3), https://ghrc.nsstc.nasa.gov/home/field-campaigns/camex3; Meteorological Measurement System, https://www.nasa.gov/meteorological-measurement-system/; Meteorological Measurement System (MMS), https://airbornescience.nasa.gov/instrument/MMS, the entire disclosures of which are incorporated herein by reference. Sub-grid refinement in compressible flow at the torus-ambient atmosphere interface is implemented with a radiative transfer model that is albedo dependent. Vorticity generation is tracked in a real time sense to provide an indication of the impact of the focused, solar energy deposition.

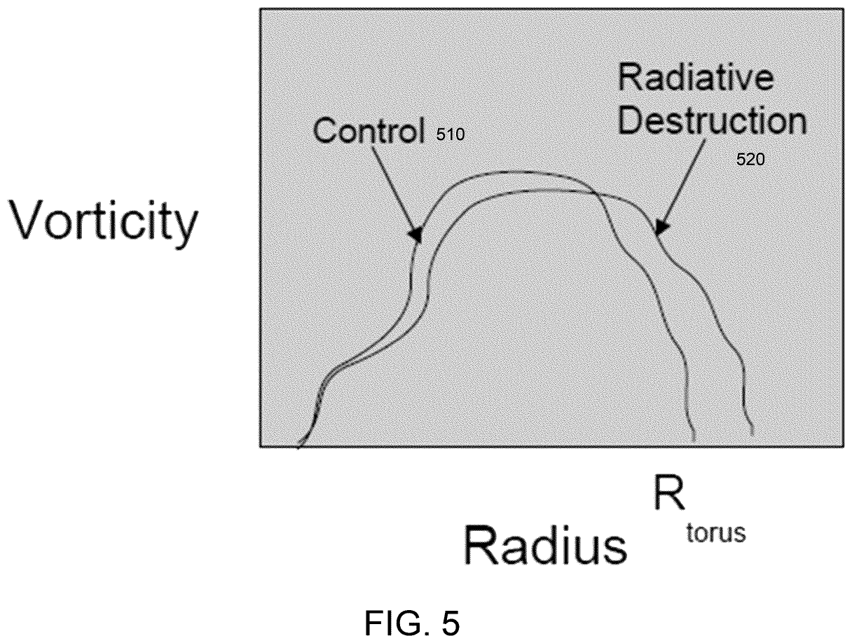

FIG. 5 illustrates an example of the relative vorticity inside the hurricane torus with and without added solar radiation. In the vorticity versus radius diagram, the relative vorticity without added solar destruction is the control plot 510. The relative vorticity with added solar destruction is the radiative destruction plot 520. The plot reveals the path of degradation inside the hurricane; that is, it shows that modification can be achieved by adding energy and that modification can reduce vorticity.

### Severe Weather Event Disruption Method

According to embodiments, a severe weather event disruption method includes three steps: (1) using finite difference computer codes to model severe weather vortex energetics (e.g., hurricane energetics) and solve the Navier Stokes equations, (2) adapting an explicit-implicit version of a code for high explosive events to capture the flow field at a time when semi-steady state exists, and (3) depositing solar energy within the torus region of the model hurricane through an energy deposition model. The hurricane event is then allowed to evolve over time (e.g., 3 to 6 hours typically). See “Adaptive Gridding in Three-Dimensional for Studying Complex Shock Interactions,” Proceedings of 16th International Symposium on Shock Tubes and Waves, Aachen, West Germany, July 1987, the entire disclosure of which is incorporated herein by reference.

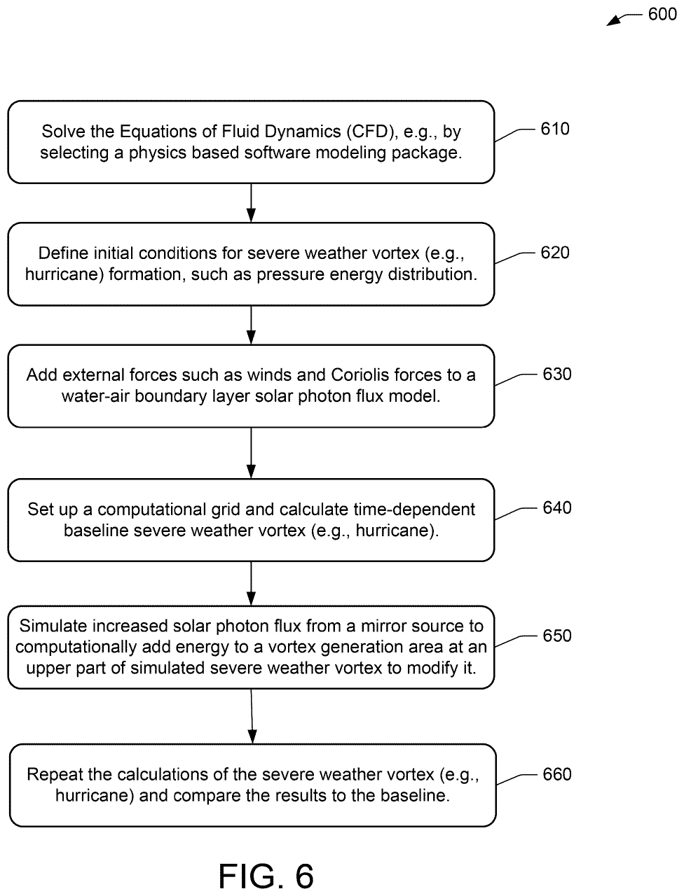

FIG. 6 shows a flow diagram 600 illustrating an example of establishing a modeling system for hurricane modification analysis. In step 610, the method selects a physics-based software modeling package (e.g., COMSOL Multiphysics® software) that computationally solves the equations of fluid dynamics, including Navier-Stokes equations. This is the computational fluid dynamics (CFD) step. Choosing a CFD code with higher order algorithms that accurately solve the first principles equations of CFD guarantees the solution of steady state and non-steady state processes. Physical conditions such as shockwaves which are present in high explosive events will be captured and modeled accurately. In step 620, the method defines initial conditions for hurricane formation. For example, this step defines an initial pressure-energy distribution.

In step 630, the method adds external forces such as Coriolis forces and external winds, variable heating of the sea water, and other energy rich phenomenon to account for energy being transferred from the water to the air and other forces. This may utilize a water-air boundary layer solar photon flux model. Radiation consists of packets of radiant energy called photons or quanta. Electromagnetic radiation is an electric and magnetic disturbance traveling through space at the speed of light. Radiation pressure arises due to the exchange of momentum between the electromagnetic field and an object. A photon flux causes a transfer of momentum. The photon flux is the number of photons per second per unit area and is important in determining the number of electrons which are generated. A solar photon flux is a flux of protons (with energies higher than 10 MeV) greater than 10 particles cm⁻¹s⁻¹ster⁻¹ (per centimeter-squared per second per steradian) for more than fifteen minutes. The solar photon flux causes solar radiation pressure. The solar photon flux may create solar wind, which is a stream of charged particles (an electrically neutral plasma consisting mostly of protons and electrons) released from the upper atmosphere of the sun called the corona. This model is an energy addition process that is time-dependent as well as spatially located in space. Once again, the first principles equations will naturally process this additional energy and their solution(s) will capture local modifications of the atmosphere.

An example of a solar photon flux model can be found in Ravinesh C. Deo et al., “Forecasting solar photosynthetic photon flux density under cloud cover effects: novel predictive model using convolutional neural network integrated with long short-term memory network,” Stochastic Environment Research and Risk Assessment 36:3183-3220 (2022), which is incorporated herein by reference in its entirety. The paper describes a deep learning hybrid model using a convolutional neural network integrated with long short-term memory (CLSTM or CNN-LSTM). It is used to model solar photosynthetic photon flux density (PPFD) to evaluate, for instance, the impact of real-time integration of photovoltaic energy in power grids, and skin cancer and eye disease risk minimization through solar ultraviolet (UV) index prediction and bio-photosynthetic processes. The objective hybrid model, CLSTM, was developed using deep learning and machine learning algorithms with implementation of both the python and the MATLAB-based scripts. The CLSTM model utilizing statistical input features can become a sophisticated deep learning system for the future development of solar energy monitoring devices and the like. The study establishes that the efficacy of the CLSTM model to forecast photosynthetic-active radiation at high temporal resolutions of 5-min that also matches a near real-time scale, can be trained on live cloud cover data or other atmospheric conditions. The CLSTM model was verified to be highly superior in predicting 5-min PPFD through 17 different predictor variable (or input) combinations.

Step 640 involves setting a computational grid and calculating a time-dependent baseline severe weather vortex (e.g., baseline hurricane). In step 650, the method simulates increased solar photon flux from a mirror source to computationally add energy to a vortex generation area at an upper part of the simulated severe weather vortex (e.g., the simulated hurricane) to modify it. In step 660, using the solar photon flux model, the method repeats the calculations of the severe weather (e.g., hurricane) and compares the results to the baseline.

An example is a numerical simulation of either a high explosive or nuclear detonation event in the atmosphere where energy is released over very short periods of time, such as microseconds for high explosives and nanoseconds (one shake=10 nanoseconds) for nuclear events. One of the keys to successfully modeling the subsequent flow with a first principles CFD code is to include an accurate equation of state for the air, especially for nuclear events. An equation of state is an equation that relates internal energy to pressure. After energy deposition into an appropriate volume, which for high explosive material is the geometry and density of the high explosive material and in the case of nuclear explosive is the geometry of the deposited X-Rays from the nuclear reactions, the effects of the additional energy will be propagated through the computation mesh. While the details of the high explosive detonation and the nuclear reactions are not modeled, the total energy deposited into the surrounding atmosphere will drive subsequent fluid motions. High explosive simulations using this approach have been shown to be very accurate in predicting later time atmospheric conditions. What is required for the model is knowledge of the energy source after the detonation events are complete. In the solar case, the energy deposition as a function of time is known.

An example of high explosive simulations can be found in “blastFoam: Comparison with Field-Scale HSE Explosive Experiments,” Synthetik Applied Technologies, published June 15, 2021, https://github.com/synthetik-technologies/blastfoam, which is incorporated herein by reference in its entirety. The paper presents comparisons of blastFoam simulation outputs with field-scale experiments. Predictions of Computational Fluid Dynamic (CFD) simulations using the blastFoam solver were compared against a field-scale experiment to investigate the effects of intervening obstacles on blast overpressure. As anticipated, the leading shock wave is the highest frequency component of the blast wave and is therefore the most affected by interaction with obstacles. The simple linear rows of square cross-section buildings provide substantial sheltering in the region of the obstacles and the blastFoam simulation is able to capture this obstacle interaction. Accurate simulations of explosive events are demonstrated.

### Results

Results to date show direct correlation between absorption of radiative energy at the edge of torus and a redistribution of vorticity. This effect leads to a diffusion of the torus and weakening trend of the hurricane event. Variations of the amount of energy; for example, varying the incident radiative energy by factors of 10 and increasing the area intercepted by a factor of ten have shown a marked divergence in the flow patterns within the torus.

Because an explicit-implicit time-step method is used for solving the equations, the study is limited to tens of hours of time scale. Because of the apparent steady-state nature of the hurricane event, one can utilize boundary conditions to reduce the volume that is modeled. The technique shows definite promise, with calculations taking overnight on a powerful PC. Additional calculations can be used to investigate the long term focusing of solar energy on the torus area.

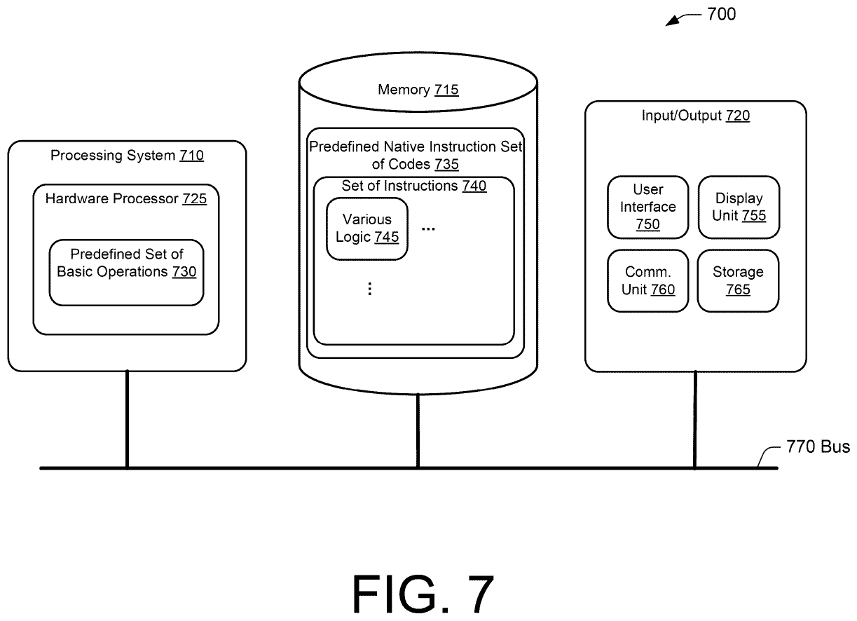

FIG. 7 illustrates a computing system 700 including logic according to an embodiment. The computing system 700 includes a processing system 710 having a hardware processor 725 configured to perform a predefined set of basic operations 730 by loading corresponding ones of a predefined native instruction set of codes 735 as stored in the memory 715. The computing system 700 further includes input/output 720 having user interface 750, display unit 755, communication unit 760, and storage 765. The computing system 700 can be used to implement some or all of the processes or operations of establishing a modeling system for hurricane modification analysis in FIG. 6.

The memory 715 is accessible to the processing system 710 via the bus 770. The memory 715 includes the predefined native instruction set of codes 735, which constitute a set of instructions 740 selectable for execution by the hardware processor 725. In an embodiment, the set of instructions 740 include logic 745 representing various processor logic and/or modules. An example of such logic 745 is set forth in greater detail with respect to the flow diagram illustrated in FIG. 6. Each of the above-mentioned algorithms (e.g., MMWI, neutron imaging, and other detection algorithms and other imaging algorithms) can be a separate system or a module in an overall computer system 700. The various logic 745 is stored in the memory 715 and comprises instructions 740 selected from the predefined native instruction set of codes 735 of the hardware processor 725, adapted to operate with the processing system 710 to implement the process or processes of the corresponding logic 745.

A hardware processor may be thought of as a complex electrical circuit that is configured to perform a predefined set of basic operations in response to receiving a corresponding basic instruction selected from a predefined native instruction set of codes. The predefined native instruction set of codes is specific to the hardware processor; the design of the processor defines the collection of basic instructions to which the processor will respond, and this collection forms the predefined native instruction set of codes. A basic instruction may be represented numerically as a series of binary values, in which case it may be referred to as a machine code. The series of binary values may be represented electrically, as inputs to the hardware processor, via electrical connections, using voltages that represent either a binary zero or a binary one. These voltages are interpreted as such by the hardware processor. Executable program code may therefore be understood to be a set of machine codes selected from the predefined native instruction set of codes. A given set of machine codes may be understood, generally, to constitute a module. A set of one or more modules may be understood to constitute an application program or “app.” An app may interact with the hardware processor directly or indirectly via an operating system. An app may be part of an operating system.

A computer program product is an article of manufacture that has a computer-readable medium with executable program code that is adapted to enable a processing system to perform various operations and actions. Non-transitory computer-readable media may be understood as a storage for the executable program code. Whereas a transitory computer-readable medium holds executable program code on the move, a non-transitory computer-readable medium is meant to hold executable program code at rest. Non-transitory computer-readable media may hold the software in its entirety, and for longer duration, compared to transitory computer-readable media that holds only a portion of the software and for a relatively short time. The term, “non-transitory computer-readable medium,” specifically excludes communication signals such as radio frequency signals in transit. The following forms of storage exemplify non-transitory computer-readable media: removable storage such as a USB disk, a USB stick, a flash disk, a flash drive, a thumb drive, an external SSD, a compact flash card, an SD card, a diskette, a tape, a compact disc, an optical disc; secondary storage such as an internal hard drive, an internal SSD, internal flash memory, internal non-volatile memory, internal DRAM, ROM, RAM, and the like; and the primary storage of a computer system.

Different terms may be used to express the relationship between executable program code and non-transitory computer-readable media. Executable program code may be written on a disc, embodied in an application-specific integrated circuit, stored in a memory chip, or loaded in a cache memory, for example. Herein, the executable program code may be said, generally, to be “in” or “on” a computer-readable media. Conversely, the computer-readable media may be said to store, to include, to hold, or to have the executable program code.

The inventive concepts taught by way of the examples discussed above are amenable to modification, rearrangement, and embodiment in several ways. For example, instead of providing a large orbital mirror, depending on the threshold energy (flux) needed to initiate modification, a set of surface ships/barges with large reflectors may be used to focus solar energy at the upper parts of the hurricane. The set of reflectors may be mounted on a plurality of water surface vehicles. See, e.g., U.S. Pat. No. 4,364,532, entitled APPARATUS FOR COLLECTING SOLAR ENERGY AT HIGH ALTITUDES AND ON FLOATING STRUCTURES; U.S. Patent No. 11,685,483, entitled INFLATABLE NON-IMAGING NON-TRACKING SOLAR CONCENTRATOR BASED SOLAR POWERED ELECTRIC SHIPS; and WO2020029170A1 entitled WATER-SURFACE SOLAR ENERGY APPARATUS, the entire disclosures of which are incorporated herein by reference. Accordingly, although the present disclosure has been described with reference to specific embodiments and examples, persons skilled in the art will recognize that changes may be made in form and detail without departing from the spirit and scope of the disclosure.

Certain attributes, functions, steps of methods, or sub-steps of methods described herein may be associated with physical structures or components, such as a module of a physical device that, in implementations in accordance with this disclosure, make use of instructions (e.g., computer executable instructions) that are embodied in hardware, such as an application specific integrated circuit, or that may cause a computer (e.g., a general-purpose computer) executing the instructions to have defined characteristics. There may be a combination of hardware and software such as processor implementing firmware, software, and so forth so as to function as a special purpose computer with the ascribed characteristics. For example, in embodiments a module may comprise a functional hardware unit (such as a self-contained hardware or software or a combination thereof) designed to interface the other components of a system such as through use of an API. In embodiments, a module is structured to perform a function or set of functions, such as in accordance with a described algorithm. This disclosure may use nomenclature that associates a component or module with a function, purpose, step, or sub-step to identify the corresponding structure which, in instances, includes hardware and/or software that function for a specific purpose. For any computer-implemented embodiment, “means plus function” elements will use the term “means;” the terms “logic” and “module” and the like have the meaning ascribed to them above, if any, and are not to be construed as means.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

What is claimed is:

1. A system to modify a severe weather vortex, the system comprising:
a controller configured to specify initial conditions for formation of the severe weather vortex, model the severe weather vortex with equations of fluid dynamics based on the initial conditions to produce a simulated severe weather vortex, and computationally add energy to a vortex generation area at an upper part of the simulated severe weather vortex to modify the simulated severe weather vortex to disrupt at least one of a formation of the simulated severe weather vortex or a travel path of the simulated severe weather vortex; and
a steerable mirror oriented to focus solar energy from the sun at a vortex generation area at an upper part of the severe weather vortex based on the energy computationally added to modify the simulated severe weather vortex.

2. The system of claim 1,
wherein the steerable mirror comprises an orbital mirror stationed at a geosynchronous orbit.

3. The system of claim 1,
wherein the steerable mirror comprises a set of reflectors mounted on a plurality of water surface vehicles.

4. The system of claim 1,
wherein the steerable mirror comprises a substrate, a reflective layer disposed on the substrate for reflecting the solar energy, and an interference layer disposed on the substrate.

5. The system of claim 1,
wherein the steerable mirror is over a hundred square meters in size.

6. The system of claim 1,
wherein the equations of fluid dynamics comprise Navier Stokes equations;
wherein modeling the severe weather vortex comprises using finite difference computer codes to model severe weather vortex energetics and solve the Navier Stokes equations; and
wherein computationally adding energy comprises adapting an explicit-implicit version of a code for high explosive events to capture a flow field of the simulated severe weather vortex at a time when a semi-steady state exists that allows the simulated severe weather vortex to persist until landfall or cooler ocean waters are encountered, and computationally depositing solar energy in the vortex generation area in a torus region of the simulated severe weather vortex through an energy deposition model.

7. The system of claim 1,
wherein computationally adding energy comprises computationally adding external forces based on a solar photon flux model.

8. The system of claim 7, wherein the controller is configured to:
set up a computational grid and calculate a time-dependent baseline severe weather vortex.

9. The system of claim 8, wherein the controller is configured to:
simulate increased solar photon flux from a mirror source to computationally add energy to the vortex generation area at the upper part of the simulated severe weather vortex to modify the simulated severe weather vortex;
compare the modified simulated severe weather vortex to the time-dependent baseline severe weather vortex until the simulated severe weather vortex is sufficiently disrupted to be degraded from severe weather vortex status; and
steer the steerable mirror to focus solar energy from the sun at the upper part of the severe weather vortex to modify the severe weather vortex based on the increased solar photon flux from the mirror source simulated to computationally add energy to modify the simulated severe weather vortex.

10. The system of claim 1,
wherein computationally adding energy to modify the simulated severe weather vortex comprises reducing a 3D (3 dimensional) vorticity of the simulated severe weather vortex to a 2D (2 dimensional) vorticity.

11. A method of modifying a severe weather vortex, the method comprising:
specifying initial conditions for formation of the severe weather vortex;
modeling the severe weather vortex with equations of fluid dynamics based on the initial conditions to produce a simulated severe weather vortex;
computationally adding energy to a vortex generation area at an upper part of the simulated severe weather vortex to modify the simulated severe weather vortex to disrupt at least one of a formation of the simulated severe weather vortex or a travel path of the simulated severe weather vortex; and
steering a mirror to focus solar energy from the sun at an upper part of the severe weather vortex to modify the severe weather vortex based on the energy computationally added to modify the simulated severe weather vortex.

12. The method of claim 11,
wherein the equations of fluid dynamics comprise Navier Stokes equations; and
wherein modeling the severe weather vortex comprises using finite difference computer codes to model severe weather vortex energetics and solve the Navier Stokes equations.

13. The method of claim 11,
wherein computationally adding energy comprises adapting an explicit-implicit version of a code for high explosive events to capture a flow field of the simulated severe weather vortex at a time when a semi-steady state exists that allows the simulated severe weather vortex to persist until landfall or cooler ocean waters are encountered.

14. The method of claim 11,
wherein computationally adding energy comprises computationally depositing solar energy in the vortex generation area in a torus region of the simulated severe weather vortex through an energy deposition model.

15. The method of claim 11,
wherein computationally adding energy comprises computationally adding external forces based on a solar photon flux model.

16. The method of claim 15, further comprising:
setting up a computational grid and calculating a time-dependent baseline severe weather vortex.

17. The method of claim 16, further comprising:
simulating increased solar photon flux from a mirror source to computationally add energy to the vortex generation area at the upper part of the simulated severe weather vortex to modify the simulated severe weather vortex;
comparing the modified simulated severe weather vortex to the time-dependent baseline severe weather vortex until the simulated severe weather vortex is sufficiently disrupted to be degraded from severe weather vortex status; and
steering the mirror to focus solar energy from the sun at the upper part of the severe weather vortex to modify the severe weather vortex based on the increased solar photon flux from the mirror source simulated to computationally add energy to modify the simulated severe weather vortex.

18. The method of claim 11,
wherein computationally adding energy to modify the simulated severe weather vortex comprises reducing a 3D (3 dimensional) vorticity of the simulated severe weather vortex to a 2D (2 dimensional) vorticity.

19. The method of claim 11,
wherein steering the mirror comprises steering an orbital mirror stationed at a geosynchronous orbit.

20. The method of claim 11,
wherein steering the mirror comprises steering a set of reflectors mounted on a plurality of water surface vehicles.

21. A non-transitory computer-readable recording medium storing a program including instructions that cause a processor to execute a severe weather vortex modification operation of a severe weather vortex, comprising:
specifying initial conditions for formation of the severe weather vortex;
modeling the severe weather vortex with equations of fluid dynamics based on the initial conditions to produce a simulated severe weather vortex;
computationally adding energy to a vortex generation area at an upper part of the simulated severe weather vortex to modify the simulated severe weather vortex to disrupt at least one of a formation of the simulated severe weather vortex or a travel path of the simulated severe weather vortex; and
generating instructions on steering a mirror to focus solar energy from the sun at an upper part of the severe weather vortex to modify the severe weather vortex based on the energy computationally added to modify the simulated severe weather vortex.

22. The non-transitory computer-readable recording medium of claim 21,
wherein the equations of fluid dynamics comprise Navier Stokes equations; and
wherein modeling the severe weather vortex comprises using finite difference computer codes to model severe weather vortex energetics and solve the Navier Stokes equations.

23. The non-transitory computer-readable recording medium of claim 21,
wherein computationally adding energy comprises adapting an explicit-implicit version of a code for high explosive events to capture a flow field of the simulated severe weather vortex at a time when a semi-steady state exists that allows the simulated severe weather vortex to persist until landfall or cooler ocean waters are encountered.

24. The non-transitory computer-readable recording medium of claim 21,
wherein computationally adding energy comprises computationally depositing solar energy in the vortex generation area in a torus region of the simulated severe weather vortex through an energy deposition model.

25. The non-transitory computer-readable recording medium of claim 21,
wherein computationally adding energy comprises computationally adding external forces based on a solar photon flux model.

26. The non-transitory computer-readable recording medium of claim 25, the severe weather vortex modification operation further comprising:
setting up a computational grid and calculating a time-dependent baseline severe weather vortex.

27. The non-transitory computer-readable recording medium of claim 26, the severe weather vortex modification operation further comprising:
simulating increased solar photon flux from a mirror source to computationally add energy to the vortex generation area at the upper part of the simulated severe weather vortex to modify the simulated severe weather vortex;
comparing the modified simulated severe weather vortex to the time-dependent baseline severe weather vortex until the simulated severe weather vortex is sufficiently disrupted to be degraded from severe weather vortex status; and
generating instructions on steering the mirror to focus solar energy from the sun at the upper part of the severe weather vortex to modify the severe weather vortex based on the increased solar photon flux from the mirror source simulated to computationally add energy to modify the simulated severe weather vortex.

28. The non-transitory computer-readable recording medium of claim 21,
wherein computationally adding energy to modify the simulated severe weather vortex comprises reducing a 3D (3 dimensional) vorticity of the simulated severe weather vortex to a 2D (2 dimensional) vorticity.

29. The non-transitory computer-readable recording medium of claim 21,
wherein the instructions on steering the mirror comprise instructions on steering an orbital mirror stationed at a geosynchronous orbit.

30. The non-transitory computer-readable recording medium of claim 21,
wherein the instructions on steering the mirror comprise instructions on steering a set of reflectors mounted on a plurality of water surface vehicles.
